(19) United States
(12) Patent Application Publication
(10) Pub. No.: US 2012/0199576 A1
(43) Pub. Date: Aug. 9, 2012

(54) Low Resistance Electric Heating System

(76) Inventor: Paul Lenworth Mantock, Hayes (GB)

(21) Appl. No.: 13/381,162

(22) PCT Filed: Jul. 1, 2010
(86) PCT No.: PCT/GB10/01266

§ 371 Date: Jan. 19, 2012

(30) Foreign Application Priority Data
Jul. 1, 2009 (GB) 0911410.9

(51) Int. Cl. H05B 3/10

(52) U.S. Cl. 219/552

(57) ABSTRACT

A low resistance electric heating system comprising a low resistance electric conducting material being formed into an electric heating element 10 in two flat spiraled sections 10a and 10b covering almost all the area to be heated, comprising a low resistance electric conducting material with sufficient resistance to generate heat. The flat spiraled sections 10a and 10b of the electric heating element 10 are spirally configured, so that the heat generating current flows in the same direction and not in opposition in each of the flat spiraled sections 10a and 10b. The centre 10c of each of the flat spiraled sections 10a and 10b of the electric heating element 10 are electrically connected to each other in series. The flat spiraled sections 10a and 10b are connected to the controlled power supply 11 at the outer part of the flat spiral 10d, completing the circuit.

### CROSS-REFERENCE TO RELATED APPLICATION

This application claims priority date of Patent Application No. 0911410.9 (GB) filed 2009 Jul. 1 by the present inventor.

### FEDERALLY SPONSERED RESEARCH

Not Applicable

### SEQUENCE LISTING OR PROGRAM

Not Applicable

### BACKGROUND OF INVENTION

### Field of Invention

The generation of heat by electric energy is well known. It requires a heating element, comprised of an electric conducting material with sufficient resistance to generate heat, when an electric current is driven through it by a potential difference across it from a power source. The power P watts required to generate heat is related to the current 1 amps through the heating element, its resistance R ohms and the potential difference V volts across it by the following relationships,

P=I²R=VI watts.

The above equation is heat generated at a temperature where the electric energy is completely converted to heat. The energy conversion temperature is greater than the melting temperature of many electric conducting materials, necessitating the heating element being comprised of an alloy of high resistance, that will reach its energy conversion temperature well before it reaches its melting temperature. The energy conversion temperature for such alloys is much higher than the required temperature, making it necessary for the temperature to be controlled at the required temperature. And the high resistance of heating element has a suitable rate of heating, enabling a thermostatic switch to have time respond to keep the required temperature as near constant as possible. The problem is that, the higher the resistance of the heating element, the higher the current and the higher the potential difference it requires across it, to power the current through it, to generate heat, requiring more power and hence more electric energy to generate heat.

An efficient way to distribute heat over a surface to be heated is to have the heating element covering, as completely as possible, the surface to be heated. This could be achieved by a foil with sufficient length. The problem is that, the resistance of the heating element is directly related to its resistivity and geometry, and because the alloys used in current heating elements already have a high resistance, it will have a high resistivity. A foil will also have a very much reduced cross-sectional area and increasing its length, increases its resistance even more, requiring even more power and hence more electric energy to generate heat. This limitation of the geometry of the heating element limits the way in which it can be used to provide heat. It is for this reason a second medium such as water or oil is used to transfer heat from the heating element to the surface of, for example, a panel radiator, because water or oil distributes heat more efficiently and the relatively slow rate of temperature rise of the water or oil allows the thermostat time to respond to temperature change, resulting in a safe surface temperature.

Almost all domestic and many industrial electric heating applications occur at temperatures below the inching temperature of low resistant electric conducting materials such as copper and aluminium. The following relationship P=I²R=VI watts, suggests that if the resistance of the heating element can be reduced, the power required to generate heat will be reduced. The problem with low resistance electric conducting materials such as copper or aluminium is that they heat up to their melting temperature very rapidly when connected to a uncontrolled power supply. It is for this reason they are used as fuse wires.

If a controlled power supply, where the voltage across the electric heating element and the current being driven through it, are controlled to supply a limited amount of power, by employing a purely capacitive impedance component in the form of a zero loss capacitor, which rigidly controls any current being transmitted through it in the following way,

I=2πfCVs,

because it has zero resistance and inductance. It could be combined with a transformer to step up or step down to the require voltage across the electric heating element. The electric heating element would then only receive sufficient amount of power, generating heat at a temperature at a suitable rate of heating, but safely below its melting temperature. The resistance of the heating element could be reduced by using a low resistance electric conducing material. The electric heating element could then be made from an electric conducting material foil, without much increase of the resistance of the heating element, to cover the area or increase the surface area to be heated, increasing heating efficiency, thereby reducing the power and hence reducing the electric energy required to generate heat.

When a current flows in an electric heating element it generates an electromagnetic field until it reaches its energy conversion temperature. If the electric heating element is configured so that it has opposing current flow, the generated electromagnetic field will be in opposition, which will reduce the heating effect of the current, thereby reducing the efficiency of the electric heating element. Therefore the electric heating element has to be configured so that the heating current flows in the same direction, so that the electromagnetic field is not in opposition with each other increasing the efficiency of heat generation. Some the generated electromagnetic field is also lost because it is induced away from the heating element reducing the heat being generated by the heat generating current. By providing an electromagnetic field deflector the induced away electromagnetic field can be re-induce into the electric heating element boosting the heat generating current and increasing the heating efficiency of the electric heating element.

The present invention is a low resistance electric heating system comprising, a low resistance electric conducting material being formed into an electric heating element to generate heat. A low resistance electric conducting material being defined; as an electric conducting material of such resistance that when used as an electric heating element by connecting it to an uncontrolled power supply, the electric conducting material will reach its melting temperature and melt, before it reaches an energy conversion temperature. The electric heating element is configured in such a way, so that the current flowing through it, flows in the same direction, so that the generated electromagnetic field are not in opposition, thereby increasing heating efficiency. The electric heating element is connected to a AC or DC controlled power supply, where the voltage across the electric heating element and the current through the electric heating element are controlled to limit the power to the electric heating element. The controlled power supply controls the amount of power to the electric heating element, hence limiting the temperature of the electric heating element to an energy transition temperature safely below the melting temperature of the low resistance electric conducting material forming the electric heating element, thereby reducing the energy required to generate heat at or near a required temperature. The low resistance electric heating system is provided with a electromagnet field deflector, formed from an electric conducting material, to re-induce, induced away the electromagnet field. boosting the heat generating current, thereby increasing the heat generating efficiency of the electric heating element.

The invention will now be described by the following drawings.

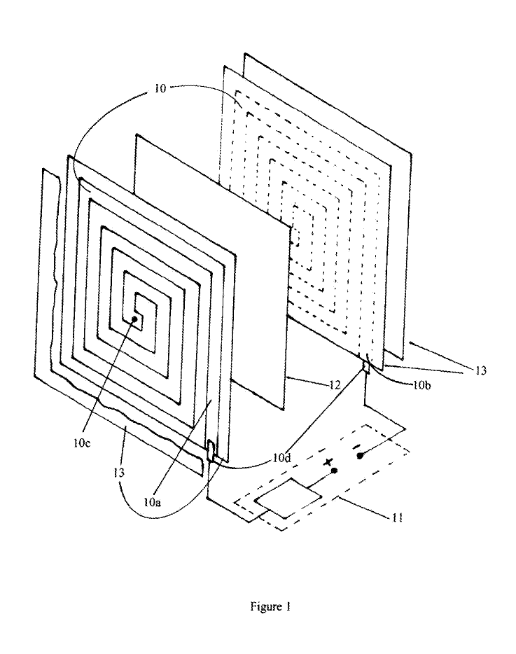

FIG. 1 shows in perspective the components, separated from each other, of the low resistance electric heating system connected to a controlled power supply.

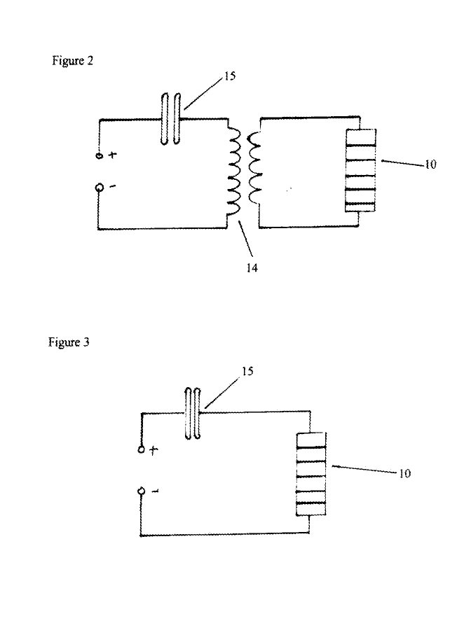

FIG. 2 shows the first embodiment of a controlled power supply circuit.

FIG. 3 shows the second embodiment of a controlled power supply circuit

FIG. 1 shows in perspective the components of the low resistance electric heating system comprising a low resistance electric conducting material being formed into an electric heating element 10 in two flat spiraled sections 10a and 10b covering almost all the area to be heated, comprising a low resistance electric conducting material with sufficient resistance to generate heat. The flat spiraled sections 10a and 10b of the electric heating element 10 are spirally configured, so that the heat generating current flows in the same direction and not in opposition in each of the flat spiraled sections 10a and 10b. The centre 10c of each of the flat spiraled sections 10a and 10b of the electric heating element 10 are electrically connected to each other in series.

The flat spiraled sections 10a and 10b are conveniently connected to the controlled power supply 11 at the outer part of the flat spiral 10d, completing the circuit. The spiraled sections 10a and 10b are connected in this way so that the connecting means, that connects the electric heating element 10 to the controlled power supply 11 does not cross the flat spiraled sections 10a and 10b of the electric heating element 10. The low resistance electric heating system is provided with a sheet of an electric conducting material as an electromagnetic field deflector 12. Thee electromagnetic field deflector 12, is enclosed by the two sections 10a and 10b of the electric heating element 10 and is electrically insulated from each other by a heat conducting electric insulating material 13. The electromagnetic field generated by the heat generating current flowing through the two sections 10a and 10b of the electric heating element 10, is deflected and re-induced by the electromagnetic field deflector 12, boosting the heat generating current. The whole assembly is provided with heat conducting electrically insulating material 13 (shown cut away at the outer surface of section 10a of the electric heating element 10) at the outer surfaces of the two sections 10a and 10b of the electric heating element 10, so that the surface to be heated is electrically insulated from the two sections 10a and 10b of the electric heating element 10. A thermostatic means (not shown) is provided to control the temperature of the electric heating element 10.

FIG. 2 shows the first embodiment of the controlled power supply circuit comprising a transformer 14 to control the voltage across the electric heating element 10 and a zero loss capacitor 15 to control the heat generating current though the electric heating element 10.

FIG. 3 shows the second embodiment of controlled power supply circuit comprising at least one zero loss capacitor 15 to control the voltage across the electric heating element 10 and the heat generating current through the electric heating element.

1. A low resistance electric heating system comprising;
a low resistance electric conducting material being formed into an electric heating element and the said low resistance electric conducting material being defined as;
an electric conducting material of such resistance that when the said electric conducting material of such resistance is used as the said electric heating element by connecting it to an uncontrolled power supply, the said electric conducting material of such resistance will reach its melting temperature and melt, before the said electric conducting material of such resistance being used as the said electric heating element reaches a temperature where the electric energy is converted to heat
and the said low resistance electric conducting material being used as the said electric heating element being provided with power from a controlled power supply,
and the power from the said power supply is rigidly controlled by a capacitive device therein,
and the said capacitive device therein the said power supply is of a desired capacitance
and the desired capacitance of the said capacitive device being the means rigidly controlling the current being transmitted through the said capacitive device, thereby limiting the power output of the said power supply, thereby controlling the current through the said low resistance electric conducting material being used as the said electric heating element
and the said controlled power supply being provided with the means therein to control the voltage across the said electric heating element so that when power is provided to the said low resistance electric conducting material being used as the said electric heating element it is the means by which the power supplied to the said electric heating element, is limited, controlling the current through the said electric heating element ensuring that heat is generated and controlling temperature at which energy conversion occurs, safely below the melting temperature of the said electric heating element, thereby reducing the energy required to generate heat.

2. A low resistance electric heating system comprising;
a low resistance electric conducting material being formed into a electric heating element and the said low resistance electric conducting material being configured spirally flat to form at least one section of the said electric heating element and the at least one section of the said configured spirally flat said electric heating element being electrically connected to another of the said at least one section configured spirally flat said electric heating element
and each of the at least one section said configured spirally flat said electric heating element being electrically connected at the centre of each spiral
and the said electric heating element is provided with an electromagnetic field deflector and the said electromagnetic field deflector is the means by which the electromagnetic field being generated from the heat generating current flowing through the said electric heating element is deflected and being re-induced into the said electric heating element, boosting the heat generating current, thereby increasing the heat generating efficiency of the said electric heating element
and each of the at least one section said configured spirally flat said electric heating element being provided with the means to be connected to a controlled power supply.

3. A low resistance electric heating system as in claim 1 and claim 2 wherein the said electric heating element comprises, a low resistance electric conducting material, as defined in claim 1.

4. A low resistance electric heating system as in claim 2 wherein the said electric heating element is provided with an electromagnet field deflector.

5. A low resistance electric heating system as in claim 2 wherein the said electric heating element is configured spirally flat.

6. A low resistance electric heating system as in claim 1 and claim 2 wherein the said controlled power supply comprising,
a voltage controlling and a heat generating current controlling device being combined and the said combined voltage controlling and heat generating current device comprising,
at least one voltage controlling device and the said voltage controlling device being the means to control the voltage across the said electric heating element,
and least one heat generating current controlling device being the means to control the heat generating current through the said electric heating element.

7. A low resistance electric heating system as in claim 1 and claim 2 wherein the said controlled power supply comprising,
at least one voltage controlling and heat generating current controlling device and the said voltage controlling and heat generating current controlling device being the means to control the voltage across the said electric heating element and the heat generating current through the said electric heating element.
